(19) United States
(12) Patent Application Publication
(10) Pub. No.: US 2025/0043180 A1
(43) Pub. Date: Feb. 6, 2025

(54) LUMINOPHORE, LUMINOPHORE MIXTURE, METHOD FOR PRODUCING A LUMINOPHORE AND RADIATION-EMITTING COMPONENT

(71) Applicant: ams-OSRAM International GmbH, Regensburg (DE)

(72) Inventors: Mark VORSTHOVE, Augsburg (DE); Christiane STOLL, Schwabmuenchen (DE); Daniel BICHLER, Augsburg (DE); Dominik BAUMANN, Muenchen (DE); Frauke PHILIPP, Augsburg (DE); Simon DALLMEIR, Landsberg am Lech (DE)

(21) Appl. No.: 18/714,581

(22) PCT Filed: Dec. 6, 2022
(86) PCT No.: PCT/EP2022/084487

§ 371 Date: May 30, 2024

(30) Foreign Application Priority Data
Dec. 6, 2021 (DE) 102021132004.6

(51) Int. Cl. C09K 11/77; H05B 33/14

(52) U.S. Cl. CPC C09K 11/77346; H05B 33/14

(57) ABSTRACT

A luminophore with the general formula Sr_{1-b}Ba_{b}Li₃Al₁₋ₓGaₓO_{4-y}N_{y}:Eu is provided, where 0≤b≤1, 0<x≤1 and 0≤y≤1. A luminophore mixture containing at least two luminophores selected from the group consisting of a luminophore (1) having the general formula Sr_{1-b}Ba_{b}Li₃Al₁₋ₓGaₓO_{4-y}N_{y}:Eu, where 0≤b≤1, 0<x≤1 and 0≤y≤1, which crystallizes in a triclinic crystal structure, a luminophore (1) having the general formula Sr_{1-b}Ba_{b}Li₃Al₁₋ₓGaₓO_{4-y}N_{y}:Eu, where 0≤b 1, 0<x≤1 and 0≤y≤1, which crystallizes in a monoclinic crystal structure, and a luminophore (1) having the general formula Sr_{1-b}Ba_{b}Li₃Al₁₋ₓGaₓO_{4-y}N_{y}:Eu, where 0≤b≤1, 0<x≤1 and 0≤y≤1, which crystallizes in a tetragonal crystal structure is also provided.

### RELATED APPLICATION(S)

This application is a US National Stage Application of International Application PCT/EP2022/084487, filed on 6 Dec. 2022, and claims priority under 35 U.S.C. § 119(a) and 35 U.S.C. § 365(b) from German Patent Application DE 102021132004.6, filed on Jun. 12, 2021, the contents of which are incorporated herein by reference in their entirety.

### FIELD

The present disclosure relates to a luminophore, a luminophore mixture, a method for producing a luminophore and a radiation-emitting component are disclosed.

### SUMMARY

Various embodiments of the present disclosure relate to a luminophore with improved properties. At least one embodiment of the present disclosure relates to a luminophore mixture with improved properties. At least one further embodiment relates to a method for producing a luminophore with improved properties. At least one further embodiment relates to a radiation-emitting component with improved properties.

A luminophore is disclosed. According to at least one embodiment, the luminophore has the general formula Sr_{1-b}Ba_{b}Li₃Al₁₋ₓGaₓO_{4-y}N_{y}:Eu, where 0≤b≤1, 0<x≤1 and 0≤y≤1. In particular, 0<y≤1 may apply, for example 0<y≤0.25.

The term “luminophore” is understood here and in the following to mean a wavelength conversion substance, i.e. a material that is set up to absorb and emit electromagnetic radiation. In particular, the luminophore absorbs electromagnetic radiation that has a different wavelength maximum than the electromagnetic radiation emitted by the luminophore. For example, the luminophore absorbs radiation with a wavelength maximum at shorter wavelengths than the emission maximum and thus emits radiation with an emission maximum shifted towards red. Pure scattering or pure absorption are not understood as wavelength-converting in the present case.

Here and in the following, luminophores are described with total formulae. With the formulae given, it is possible that the luminophore comprises further elements, for example in the form of contaminants, these contaminants together being present in the luminophore in a proportion of at most 5 mol %, in particular at most 1 mol %, e.g., at most 0.1 mol %.

The luminophore is composed of elements that are present in the luminophore as ions, i.e. anions or cations. Here and in the following, the components of the luminophore, Sr, Ba, Li, Al, Ga, O, N and Eu, are referred to both as elements and as ions, cations or anions. For the sake of clarity, specific elements are not necessarily indicated together with their charge. In particular, Sr, Ba, Li, Al, Ga and Eu are present as cations, while 0 and N are present as anions. Eu in particular has a double positive charge and can therefore also be specified as Eu²⁺

The luminophore can be outwardly uncharged. This means that there can be a complete charge balance between positive and negative charges on the outside of the luminophore. On the other hand, it is also possible that the luminophore formally does not have a complete charge balance to a small extent.

In particular, the luminophore can have a crystalline, for example ceramic, host material into which Eu is incorporated as an activator element. The luminophore is a ceramic material, for example.

The activator element Eu changes the electronic structure of the host material in such a way that electromagnetic radiation of a first wavelength range can be absorbed by the luminophore. This so-called primary radiation can excite an electronic transition in the luminophore, which can return to the ground state by emitting electromagnetic radiation of a second wavelength range, also known as secondary radiation. The activator element, which is introduced into the host material, is thus responsible for the wavelength-converting properties of the luminophore.

A luminophore described here can, for example, emit secondary radiation in the yellow or yellow-green spectral range when excited with primary radiation from the blue or UV spectral range. It can thus be used in particular in radiation-emitting components, such as white light-emitting LEDs (LED: light-emitting diode), in which a semiconductor chip emits blue primary radiation, which is partially converted into secondary radiation by the luminophore. Alternatively, the luminophore described here can also be used for yellow or yellow/green full conversion in an LED, for example. It is also well suited for use in displays or projectors, for example.

Compared to conventionally used yellow or green-yellow emitting luminophores, such as YAG (Y₃Al₅O₁₂:Ce³⁺), the luminophore described in various embodiments can have several advantages. For example, it has a smaller full width at half maximum (FWHM) than the full width at half maximum of over 100 nm, typically from 110 nm to 125 nm, of YAG. Here and in the following, a full width at half maximum is understood to be the spectral width at half the height of the maximum of an emission peak or an emission band. The reduced full width at half maximum compared to known luminophores can lead to increased luminous efficacy, which can be advantageous for most conversion applications. An improved visual efficiency compared to conventional luminophores can also result from the low FWHM of the luminophore described here.

Furthermore, the chromaticity coordinate of the emitted radiation can be shifted in the luminophore described here, firstly by changing the Al/Ga ratio and secondly by increasing or decreasing the proportion of Sr compared to the proportion of Ba. For example, the emitted spectrum is shifted from the yellow to the green spectral range when the Ga and/or Ba content increases.

Furthermore, the incorporation of nitrogen into the structure of the luminophore described here results in additional stabilization. This allows, for example, a second emission band—if present—to be suppressed, which means that the resulting single emission band is significantly narrower than two superimposed bands. The emission can also be further adjusted by the presence of nitrogen.

The advantages of the luminophore of various embodiments described here can come into their own both when it is used alone in a conversion element, for example in an LED, and when it is used in combination with other luminophores.

According to at least one embodiment, the luminophore crystallizes in a triclinic crystal structure. In particular, the luminophore crystallizes in the triclinic space group P1̅. This can be determined, for example, by means of single crystal X-ray diffraction. According to at least one embodiment, the luminophore crystallizes in the triclinic space group P1̅ and has lattice parameters that have the following ranges: 570 pm≤a≤590 pm, 725 pm≤b≤750 pm, 970 pm≤c≤990 pm, 75°≤α≤95°, 65°≤β≤85°, 70°≤γ≤90°.

If the luminophore crystallizes in the triclinic space group P1̅ both Li(O,N)₄ tetrahedra and mixed (Ga,Al)(O,N)₄ tetrahedra are present, each of which has common edges and/or corners. Li(O,N)₄ tetrahedra can also be linked to each other via common edges and/or corners, whereas Ga/AlO,N)₄ tetrahedra are not. The tetrahedra are each spanned by four oxygen atoms or by three oxygen atoms and one nitrogen atom or by two oxygen atoms and two nitrogen atoms or by one oxygen atom and three nitrogen atoms or by four nitrogen atoms. Li or Ga and/or Al are arranged in the resulting tetrahedral gaps. Sr and/or Ba, each of which is eightfold coordinated, is arranged in channels formed by the tetrahedra. There are also channels that are free of Sr and/or Ba.

According to at least one embodiment, the luminophore crystallizes in a monoclinic crystal structure. In particular, the luminophore crystallizes in the monoclinic space group C2/m. This can be determined, for example, by means of single crystal X-ray diffraction. According to at least one embodiment, the luminophore crystallizes in the monoclinic space group C2/m and has lattice parameters that have the following ranges: 1585 pm≤a≤1605 pm, 635 pm≤b≤<655 pm, 790 pm≤c≤805 pm, β is approx. 90°. For example, a=1596(1), b=647(1), c=797(1) pm and β=90.00(1)°. In this embodiment, a cell volume can be 0.8238(5) nm³, for example.

If the luminophore crystallizes in the monoclinic space group C2/m, both Ga(O,N)₄ tetrahedra and (Ga,Li) (O,N)₄ tetrahedra are present, wherein the Ga sites can alternatively or additionally be occupied by Al. The tetrahedra each have common edges and/or corners, wherein two (Ga,Li) (O,N)₄ tetrahedra can also have a common edge with each other. The tetrahedra are each spanned by four oxygen atoms or by three oxygen atoms and one nitrogen atom or by two oxygen atoms and two nitrogen atoms or by one oxygen atom and three nitrogen atoms or by four nitrogen atoms. Li or Ga and/or Al are arranged in the resulting tetrahedral gaps. Ba and/or Sr, each of which is eightfold coordinated, is located in the respective channels formed by the tetrahedra. There are also channels that are free of Sr and/or Ba.

According to at least one embodiment, the luminophore crystallizes in a tetragonal crystal structure. In particular, the luminophore crystallizes in the tetragonal space group I4/m. This can be determined, for example, by means of single crystal X-ray diffraction.

If the luminophore crystallizes in the tetragonal space group I4/m, (Li,Ga,Al) (O,N)₄ tetrahedra are present, which are corner- and/or edge-linked. The tetrahedra are each spanned by four oxygen atoms or by three oxygen atoms and one nitrogen atom or by two oxygen atoms and two nitrogen atoms or by one oxygen atom and three nitrogen atoms or by four nitrogen atoms. The tetrahedra form channels in which Sr or Ba atoms are arranged or which are free of Ba or Ba atoms.

The inventors have recognized that the luminophore described herein can crystallize in different space groups. It can thus crystallize either in the above-mentioned triclinic, monoclinic or tetragonal space group, or it can form a luminophore mixture or batch which contains at least two different crystallizations of the luminophore, i.e. different phases in which the luminophore is present in different crystallized states in each case. The different phases can be distinguished by means of powder X-ray diffraction.

According to at least one embodiment, the luminophore has an absorption spectrum which has an absorption maximum in the range including 400 nm to including 500 nm, in particular in the range including 400 nm to including 460 nm. The luminophore can thus be excited with blue or UV radiation and can in particular emit yellow or yellow-green light upon such excitation.

According to at least one embodiment, the luminophore has an emission spectrum comprising at least one emission peak at a wavelength in the range including 510 nm to including 580 nm. An emission peak is understood here and in the following to mean the emission with the maximum intensity, whereby this can also be a local maximum. According to at least one embodiment, the luminophore has an emission spectrum that has exactly one emission peak or exactly two emission peaks in the range including 510 nm to including 580 nm. If two emission peaks are present, they can be superimposed to form a common emission band. The luminophore thus emits yellow or yellow-green radiation, particularly when excited with radiation from the blue or UV range.

According to at least one embodiment, the luminophore has an emission spectrum which has a dominant wavelength selected from the range including 540 nm to including 580 nm, in particular from the range including 545 nm to including 575 nm. The dominant wavelength is used to characterize the color impression of the emitted radiation.

According to at least one embodiment, the at least one emission peak has a full width at half maximum that is less than 75 nm, in particular less than 60 nm, for example less than 50 nm. This provides a luminophore which has a particularly narrow-band emission, which is significantly reduced in its full width at half maximum compared to conventional yellow or yellow-green emitting luminophores, and which therefore has an increased efficiency, for example.

According to at least one embodiment, the activator Eu in the luminophore has a concentration of up to and including 10 mol %, in particular of up to and including 5 mol %, for example of up to and including 2 mol %, in particular of up to and including 1 mol %, with respect to the total content of Sr and Ba.

According to at least one embodiment, the luminophore comprises one of the compositions Sr₁Li₃Ga₁O₄:Eu, Sr₁Li₃Ga₁O_{3,75}N_{0,25}:Eu, Sr₁Li₃Al_{0,8}Ga_{0,2}O_{3,75}N_{0,25}:Eu, Sr₁Li₃Al_{0,8}Ga_{0,2}O₄:Eu, Sr_{0,6}Ba_{0,4}Li₃Ga₁O₄:Eu, Sr_{0,5}Ba_{0,5}Li₃Al_{0,5}Ga_{0,5}O_{3,75}N_{0,25}:Eu. In the first four compositions, b=0 and therefore no Ba is present in the luminophore. In the first, second and fifth compositions, x=1 and thus no Al is present in the luminophore. In the first, fourth and fifth compositions, y=0 and thus no N is present in the luminophore.

A luminophore mixture is further disclosed. The luminophore mixture contains in particular luminophores according to the embodiments described above. All features and embodiments disclosed in connection with the luminophore thus also apply to the luminophore mixture and vice versa.

According to one embodiment, the luminophore mixture contains at least two luminophores selected from the group consisting of a luminophore having the general formula Sr_{1-b}Ba_{b}Li₃Al₁₋ₓGaₓO_{4-y}N_{y}:Eu, where 0≤b≤1, 0<≤x 1 and 0≤y≤1, which crystallizes in a triclinic crystal structure, in particular in the triclinic space group P1̅, luminophore with the general formula Sr_{1-b}Ba_{b}Li₃Al₁₋ₓGaₓO_{4-y}N_{y}:Eu, where 0≤b≤1, 0<≤x 1 and 0≤y≤1, which crystallizes in a monoclinic crystal structure, in particular in the monoclinic space group C2/m, and luminophore with the general formula Sr_{1-b}Ba_{b}Li₃Al₁₋ₓGaₓO_{4-y}N_{y}:Eu, where 0≤b≤1, 0<≤x 1 and 0≤y≤1, which crystallizes in a tetragonal crystal structure, in particular in the tetragonal space group I/4m.

The luminophore mixture may contain two or three luminophores which have the same composition and differ only in their crystal structure, or two or three luminophores which differ both in their composition and in their crystal structure. The different crystal structures, i.e. the different phases formed by the luminophores in the luminophore mixture, can be distinguished from each other by powder X-ray diffraction or single crystal X-ray diffraction, even if all the luminophores in the luminophore mixture have the same composition.

For example, the luminophore that crystallizes in the triclinic crystal structure can form the main phase in the luminophore mixture. The luminophore, which crystallizes in the tetragonal crystal structure, can be present as a secondary phase with a proportion of 5 to 10% by weight in the luminophore mixture. However, a proportion of about 75% by weight, in particular up to 65% by weight, is also conceivable for this luminophore. The luminophore, which crystallizes in the monoclinic crystal structure, can form a further secondary phase.

According to one embodiment, a luminophore mixture may contain a luminophore of the formula (Sr,Ba)Li₃(Al,Ga)O₄:Eu²⁺ which crystallizes in the triclinic space group P1̅ and a luminophore (Sr,Ba) (Li,Ga)₃Ga(O,N)₄:Eu²⁺, which crystallizes in the monoclinic space group C2/m, or consist of these luminophores.

A method for producing a luminophore is further disclosed. In particular, the method can be used to produce a luminophore as described above or a luminophore mixture as described above. All features and embodiments disclosed in connection with the luminophore or the luminophore mixture thus also apply to the method and vice versa.

According to at least one embodiment, the method is used to prepare a luminophore having the general formula Sr_{1-b}Ba_{b}Li₃Al₁₋ₓGaₓO_{4-y}N_{y}:Eu, where 0≤b≤1, 0<x≤1 and 0≤y≤1.

According to at least one embodiment, the method comprises the steps of
providing a mixture of reactants selected from a group comprising oxides, nitrides, carbonates, nitrates, oxalates, citrates and hydroxides of Sr, Ba, Li, Al, Ga and Eu, respectively, and combinations thereof,
homogeneous mixing of the reactants,
heating the reactants to a temperature selected from the range including 600° C. to including 1000° C.

According to at least one embodiment, during heating, the temperature is selected from the range including 750° C. to including 850° C., for example 800° C.

According to at least one embodiment, as reactants at least one of SrO, BaO, BaGa₂O₄, Ga₂O₃, Li₂O, SrAl₂O₄, SrGa₂O₄, GaN, Sr₃Al₂N₄ and Eu₂O₃ are selected. For example, Li₂O, SrGa₂O₄, SrO, and Eu₂O₃ are selected as reactants to produce a luminophore with the composition Sr₁Li₃Ga₁O₄:Eu, the reactants Li₂O, Ga₂O₃, GaN, SrO, and Eu₂O₃, to produce a luminophore of the composition Sr₁Li₃Ga₁O_{3,75}N_{0,25}:Eu, the reactants Li₂O, SrAl₂O₄, SrGa₂O₄, Sr₃Al₂N₄, SrO, and Eu₂O₃, to produce a luminophore of the composition Sr₁Li₃ Al_{0,8}Ga_{0,2}O_{3,75}N_{0,25}:Eu, the reactants SrO, Li₂O, SrAl₂O₄, SrGa₂O₄, and Eu₂O₃, to produce a luminophore of the composition Sr₁Li₃Al_{0,8}Ga_{0,2}O₄:Eu, the reactants SrO, BaO, Li₂O, BaGa₂O₄, SrGa₂O₄ and Eu₂O₃, to produce a luminophore of the composition Sr_{0,6}Ba_{0,4}Li₃Ga₁O₄:Eu, and the reactants SrO, BaO, Li₂O, SrAl₂O₄, SrGa₂O₄, BaGa₂O₄, Sr₃Al₂N₄ and Eu₂O₃, to produce a luminophore of the composition Sr_{0,50}Ba_{0,50} Li₃Al_{0,50}Ga_{0,50}O_{3,75} N_{0,25}:Eu.

According to at least one embodiment, the heating is carried out in a forming gas atmosphere. According to one embodiment, the forming gas atmosphere is composed of 91% N₂ and 9% H₂.

According to at least one embodiment, heating is carried out for a period of 2.5 hours to 6 hours, in particular 3.5 hours to 4.5 hours, for example 4 hours.

According to at least one embodiment, heating is carried out at normal pressure. This is a simplified method compared to conventional methods, as it can be carried out in an energy- and cost-saving manner.

During heating, the reactants are made to react and the luminophore is formed.

According to one embodiment, the method comprises a post-annealing step following the heating step. According to one embodiment, the post-annealing is carried out at a temperature in the range from including 600° C. to including 800° C. According to one embodiment, the post-annealing is carried out in an H₂ atmosphere at a temperature of less than 600° C. By post-annealing, any green emission band present can be suppressed in favor of a longer wavelength emission band in the luminophore. Furthermore, the proportion of a desired crystal structure in which the luminophore crystallizes can be increased in a targeted manner. The proportion of Eu³⁺ and Eu²⁺ in the luminophore can also be reduced by post-annealing.

A radiation-emitting component is further disclosed. According to at least one embodiment, the radiation-emitting component comprises
a semiconductor chip which, in operation, emits electromagnetic radiation of a first wavelength range from a radiation exit surface, and
a conversion element on the radiation exit surface, which comprises a luminophore described herein, which converts electromagnetic radiation of the first wavelength range into electromagnetic radiation of a second wavelength range, or comprises a luminophore mixture described herein, which converts electromagnetic radiation of the first wavelength range into electromagnetic radiation of a second wavelength range.

The above-described luminophore or the luminophore mixture are particularly suitable and intended for use in a radiation-emitting component. Features and embodiments described in connection with the luminophore, the luminophore mixture and/or the method for producing a luminophore thus also apply to the radiation-emitting component and vice versa.

The electromagnetic radiation of the first wavelength range forms the emission spectrum of the semiconductor chip and is also referred to as primary radiation.

The semiconductor chip is, for example, a light-emitting diode chip or a laser diode chip. The component can therefore be a light-emitting diode (LED) or a laser. The semiconductor chip can have an epitaxially grown semiconductor layer sequence with an active zone that is suitable for generating electromagnetic radiation. For example, the active zone has for this a pn junction, a double heterostructure, a single quantum well or a multiple quantum well structure.

During operation, the semiconductor chip can emit electromagnetic radiation, for example from the ultraviolet spectral range and/or from the visible spectral range, in particular from the blue spectral range. The primary radiation thus has wavelengths from the range 400 nm to 500 nm, in particular 400 nm to 460 nm, for example.

The conversion element, which is arranged on the radiation exit surface, is located in particular in the beam path of the semiconductor chip, so that at least some of the radiation emitted by the semiconductor chip strikes the conversion element.

The luminophore or the luminophore mixture in the conversion element converts electromagnetic radiation of the first wavelength range into electromagnetic radiation of a second wavelength range. The electromagnetic radiation of the second wavelength range forms the emission spectrum of the luminophore or the luminophore mixture and is also referred to as secondary radiation.

The electromagnetic radiation of the second wavelength range is at least partially different from the first wavelength range. The luminophore or the luminophore mixture contained in the conversion element or of which the conversion element is made imparts wavelength-converting properties to the conversion element. For example, the conversion element only partially converts the electromagnetic radiation of the semiconductor chip into electromagnetic radiation of the second wavelength range, while a further part of the electromagnetic radiation of the semiconductor chip is transmitted by the conversion element. In this case, the radiation-emitting component emits mixed light, which is composed of electromagnetic radiation of the first wavelength range and electromagnetic radiation of the second wavelength range. The mixed light includes, for example, white light. If the primary radiation is completely converted by the conversion element and/or there is no transmission of primary radiation by the conversion element, this is referred to as full conversion. In this case, the radiation-emitting component emits the secondary radiation emitted by the conversion element, in particular from the yellow or yellow-green spectral range.

Due to the nature of the luminophore described here and thus also of the luminophore mixture containing it, the component described in various embodiments of the present disclosure can have advantages over conventional components. For example, the low spectral full width at half maximum of the luminophore or the luminophore mixture leads to a significantly increased luminous efficacy, which contributes to a gain in efficiency of the component. This applies both to partial or full conversion applications, when only the luminophore or the luminophore mixture is present in the conversion element, and when the luminophore or luminophore mixture is present in the conversion element together with other luminophores. In the former case, the increased luminous efficacy corresponds directly to the efficiency gain; in the latter case, the exact size of the efficiency gain also depends on the other luminophores and the mixing ratio.

According to at least one embodiment, the conversion element is free of a further luminophore. In this case, only the luminophore or the luminophore mixture is present in the conversion element and has an increased efficiency that corresponds directly to the luminous efficacy of the luminophore or the luminophore mixture. Such a component can be used, for example, for full conversion to generate yellow or yellow-green light.

According to at least one embodiment, at least one further luminophore is present in the conversion element. In particular, the further luminophore is different from the luminophore or luminophore mixture and converts electromagnetic radiation of the first wavelength range into electromagnetic radiation of a third wavelength range.

According to one embodiment, the third wavelength range is at least partially different from the first and second wavelength ranges. For example, the further luminophore may emit electromagnetic radiation selected from the red spectral range or from the green spectral range. For example, the further luminophore may be selected from garnets, SCASN, (Ca,Sr,Ba)₂Si₅NB or CASN. The luminophore or luminophore mixture described herein and the further luminophore thus form a mixture of luminophores that converts the primary radiation in whole or in part. Such a component can be used, for example, for full or partial conversion to generate white light and has an increased efficiency due to the luminophore or luminophore mixture present in the conversion element.

According to at least one embodiment, the conversion element is designed as a conversion layer. The conversion layer can be applied to the radiation exit surface of the semiconductor chip by direct or indirect contact. In the case of indirect contact, it can be applied to the radiation exit surface by means of an adhesive layer, for example, or a potting can be applied between the radiation exit surface and the conversion element.

According to at least one embodiment, the conversion element is designed as a rotatable luminophore wheel. In this case, the conversion element is spaced from the semiconductor chip so that it can rotate about an axis of rotation. The conversion element can be circular. In this embodiment, the semiconductor chip can be a laser diode. The component can then be referred to as a Laser Activated Remote Phosphor (LARP) system and is particularly suitable for use in projectors and displays.

According to a further embodiment, the semiconductor chip, conversion layer and, if applicable, adhesive layer can also all be surrounded by a potting. For example, the semiconductor chip, conversion element and possibly an adhesive layer are then arranged in the depression of a housing in which the potting is also arranged.

A potting can have a transmittance for the primary radiation and/or the secondary radiation and/or the radiation emitted by other luminophores present that is at least 85%, e.g., 95%. Furthermore, a potting can be made of silicone or epoxy resin, for example.

According to at least one embodiment, the luminophore or the luminophore mixture in the conversion element is present as a ceramic. In such a case, the conversion layer can consist of the luminophore or luminophore mixture forming the ceramic.

According to at least one embodiment, the luminophore or the luminophore mixture in the conversion element is embedded in a matrix. In particular, the luminophore or the luminophore mixture is then present in particle form. Any other luminophores that may be present can also be embedded in the matrix, in particular in particle form. According to one embodiment, the luminophore or the luminophore mixture is present in particle form, in particular with particle sizes between including 500 nm and including 50 μm.

The matrix may, for example, comprise a material selected from a group including polymers and glass. The polymers may be selected, for example, from polystyrene, polysiloxane, polysilazane, PMMA, polycarbonate, polyacrylate, polytetrafluoroethylene, polyvinyl, silicone resin, silicone, epoxy resin and transparent synthetic rubber. Silicates, water glass and quartz glass, for example, can be selected as glass.

The use of the radiation-emitting component is also disclosed. According to one embodiment, the radiation-emitting component described herein can be used to generate white light, in particular with a low color rendering index (CRI), in displays, in vehicle headlights and in projectors.

### BRIEF DESCRIPTION OF THE DRAWINGS

Further embodiments or aspects of the present disclosure will described below in conjunction with the following drawings, wherein:

FIG. 1 shows a schematic sectional view of a radiation-emitting component according to an exemplary embodiment of the present disclosure.

FIG. 2 shows a schematic sectional view of a radiation-emitting component according to an exemplary embodiment of the present disclosure.

FIG. 3 shows the crystal structure of a luminophore according to an exemplary embodiment of the present disclosure.

FIG. 4 shows the crystal structure of a luminophore according to an exemplary embodiment of the present disclosure.

FIGS. 5A to 5F show emission spectra of luminophores according to various exemplary embodiments of the present disclosure.

FIG. 6 shows emission spectra of luminophores according to various exemplary embodiments of the present disclosure.

FIG. 7 shows a split emission spectrum of a luminophore according to an exemplary embodiment of the present disclosure.

FIGS. 8A and 8B show emission spectra of luminophores according to exemplary embodiments of the present disclosure in comparison to comparative examples.

FIG. 9 shows calculated powder diffractograms.

FIG. 10 shows the crystal structure of a luminophore according to an exemplary embodiment of the present disclosure.

### DETAILED DESCRIPTION

Elements that are identical, similar or have the same effect are marked with the same reference signs in the figures. The figures and the proportions of the elements shown in the figures should not be considered to be to scale. Rather, individual elements, in particular layer thicknesses, may be shown in exaggerated size for better visualization and/or understanding.

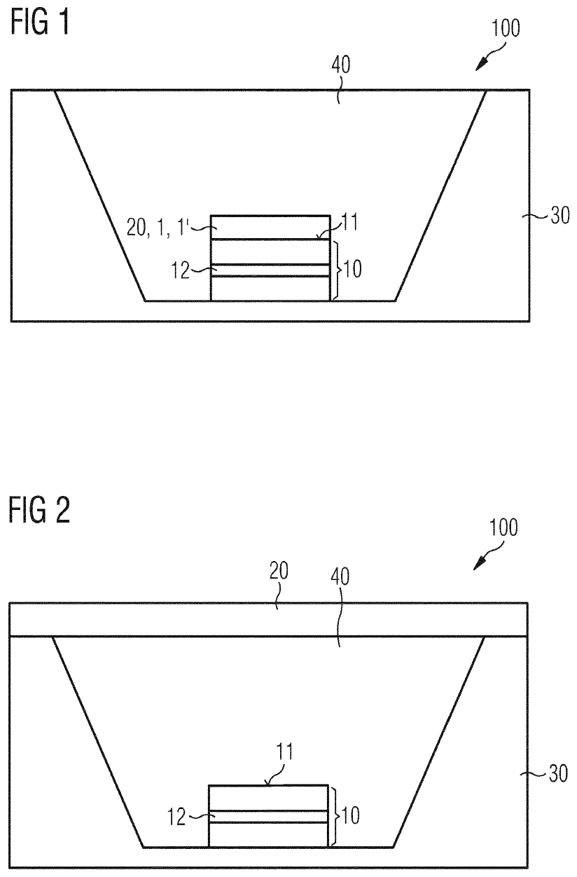

FIG. 1 shows a schematic sectional view of a radiation-emitting component according to an exemplary embodiment. The radiation-emitting component 100 has a semiconductor chip 10. During operation, the semiconductor chip 10 emits electromagnetic radiation of a first wavelength range (primary radiation) from a radiation exit surface 11. The semiconductor chip 10 has an epitaxially grown semiconductor layer sequence with an active zone 12, which is suitable for generating electromagnetic radiation. The primary radiation has wavelengths in the blue and/or ultraviolet range, for example.

Furthermore, the component has a conversion element 20. The conversion element 20 either contains a matrix in which the luminophore 1, in particular particles of the luminophore 1, is embedded in, or the conversion element 20 has or consists of a ceramic formed from the luminophore 1. Alternatively, the conversion element 20 contains a matrix in which a luminophore mixture 1′, in particular particles of the luminophore mixture 1′, is embedded, or the conversion element 20 has or consists of a ceramic formed from the luminophore mixture 1′.

The luminophore 1 or the luminophore mixture 1′ has the general formula Sr_{1-b}Ba_{b}Li₃Al₁₋ₓGaₓO_{4-y}N_{y}:Eu, wherein 0≤b≤1, 0<≤x 1 and 0≤y≤1. According to embodiments, the luminophore 1 or the luminophore mixture 1′ is embodiments A1 to A6, which are given in Table 1:

TABLE 1

| Exemplary embodiment | Composition |
|---|---|
| A1 | Sr₁Li₃Ga₁O_{3.75}N_{0.25}:Eu |
| A2 | Sr₁Li₃Ga₁O₄:Eu |
| A3 | Sr₁Li₃Al_{0.8}Ga_{0.2}O_{3.75}N_{0.25}:Eu |
| A4 | Sr₁Li₃Al_{0.8}Ga_{0.2}O₄:Eu |
| A5 | Sr_{0.6}Ba_{0.4}Li₃Ga₁O₄:Eu |
| A6 | Sr_{0.5}Ba_{0.5}Li₃Al_{0.5}Ga_{0.5}O_{3.75}N_{0.25}:Eu |

If the luminophore 1 is, for example, one of these embodiments or any other composition within the general formula Sr_{1-b}Ba_{b}Li₃Al₁₋ₓGaₓO_{4-y}N_{y}:Eu with 0≤b≤1, 0<≤x 1 and 0≤y≤1, and crystallize either in the triclinic space group P1̅, in the monoclinic space group C2/m or in the tetragonal space group I4/m. The luminophore 1 therefore only crystallizes in one crystal structure.

In the case of the luminophore mixture 1′, it may, for example, comprise two or three luminophores which independently of one another comprise one of the embodiments A1 to A6 or any other composition within the general formula Sr_{1-b}Ba_{b}Li₃Al₁₋ₓGaₓO_{4-y}N_{y}:Eu with 0≤b≤1, 0<x≤1 and 0≤y≤1, wherein each luminophore in the luminophore mixture 1′ has a different crystal structure, so that two or three different crystal structures are present in the luminophore mixture 1′. The crystal structures are selected from the triclinic space group P1̅ the monoclinic space group C2/m and the tetragonal space group I4/m. The luminophore mixture 1′ thus has several phases which differ from one another at least in their crystal structures, and possibly also in the exact composition of the luminophores.

In addition, at least one further luminophore may be present in the conversion element 20, which forms a mixture of luminophores with the luminophore 1 or the luminophore mixture 1′ described herein.

If the conversion element 20 has a matrix in which the luminophore 1, the luminophore mixture 1′ or optionally the mixture of luminophores is embedded, the matrix has a material selected from polymers such as polystyrene, polysiloxane, polysilazane, PMMA, polycarbonate, polyacrylate, polytetrafluoroethylene, polyvinyl, silicone resin, silicone, epoxy resin and transparent synthetic rubber, and glass such as silicates, water glass and quartz glass.

During operation, the luminophore 1 or the luminophore mixture 1′ converts electromagnetic radiation of the first wavelength range into electromagnetic radiation of the second wavelength range (secondary radiation). In exemplary embodiments A1 to A6, the secondary radiation is in the yellow to yellow-green range, in particular when excited with primary radiation in the blue or UV range. If the primary radiation is not completely converted by the conversion element, the component thus emits mixed light, which is composed of primary and secondary radiation and, if further luminophores are present in the conversion element 20, the emitted radiation of these further luminophores. Such a component 100 emits white light, for example.

The conversion element 20, which is designed here as a conversion layer, can either be applied directly to the semiconductor chip 10 or attached to it, for example by means of an adhesive layer (not explicitly shown here). It is also conceivable to form it as a luminophore wheel.

The semiconductor chip 10 with the conversion element 20 arranged thereon is arranged in the recess of a housing 30. The housing 30 has side surfaces which are beveled towards the semiconductor chip 10 and can be reflective. The semiconductor chip 10 and the conversion element 20 may be surrounded by a potting 40 in the housing 30, as shown here. However, the presence of a potting 40 is not absolutely necessary. The potting can be formed from a silicone or epoxy resin, for example, and has a transmittance for electromagnetic radiation of the active zone 12 that is at least 85%, e.g., 95%.

Alternatively, the housing 30 can also have no side walls and thus no recess and be designed as a carrier (not shown here).

FIG. 2 shows another exemplary embodiment of a radiation-emitting component. The explanations made with reference to FIG. 1 apply to the elements with the same reference signs. In this exemplary embodiment, the conversion element 20 is not arranged directly on the semiconductor chip 10, but spaced from it on the side of the potting 40 facing away from the semiconductor chip 10. Here too, the conversion element 20 is again formed as a conversion layer.

The components shown in FIGS. 1 and 2 are LEDs, for example. For the sake of clarity, additional elements, such as electrical contacts, are not shown in FIGS. 1 and 2. In the following, the method for producing the luminophore 1 is explained with reference to exemplary embodiments A1 to A6. The following explanations apply analogously to the luminophore mixture 1′, provided that the luminophore mixture 1′ comprises different luminophores of the same composition with different crystal structures.

Table 2 shows the reactants used for the preparation of exemplary embodiments A1 to A6 and the respective weights in g. These are weights for theoretical compounds that do not necessarily correspond to the resulting end product due to charge neutrality.

TABLE 2

| | SrO | Li₂O | SrAl₂O₄ | SrGa₂O₄ | GaN | Sr₃Al₂N₄ | BaGa₂O₄ | Eu₂O₃ | BaO | Ga₂O₃ |
|---|---|---|---|---|---|---|---|---|---|---|
| A1 | 8.47 | 3.66 | 0 | 0 | 0.68 | 0 | 0 | 0.29 | 0 | 6.89 |
| A2 | 2.1 | 1.82 | 0 | 5.92 | 0 | 0 | 0 | 0.14 | 0 | 0 |
| A3 | 3.96 | 4.28 | 6.87 | 2.78 | 0 | 1.78 | 0 | 0.34 | 0 | 0 |
| A4 | 2.45 | 2.12 | 3.89 | 1.38 | 0 | 0 | 0 | 0.17 | 0 | 0 |
| A5 | 1.17 | 1.52 | 0 | 1.02 | 0 | 0 | 5.77 | 0.12 | 2.15 | 0 |
| A6 | 0.21 | 1.81 | 1.664 | 1.178 | 0 | 0.7542 | 2.068 | 0.142 | 2.171 | 0 |

To produce the respective luminophores 1 or luminophore mixtures 1′, a flux can also be added to the reaction mixture. The flux is, for example, Li₂BO₄, of which 0.3 g (in exemplary embodiments A2 and A6) or 0.6 g (in exemplary embodiments A1 and A3 to A5) is added to the reaction mixture.

For the synthesis, stoichiometric mixtures are prepared from the respective reactants, mixed homogeneously and then heated. Heating takes place in nickel crucibles in a chamber furnace under a forming gas atmosphere (91% N₂/9% H₂) at 800° C. for 4 hours. The reactants are reacted and the resulting products contain the respective luminophore 1 or the luminophore mixture 1′.

The structures of the exemplary embodiments are characterized by means of single crystal X-ray diffraction. The lattice parameters, crystallographic data and the basic quality parameters of the X-ray diffraction determination of exemplary embodiment A2 are shown in Table 3. In the table, another example is given in the right-hand column, which can be used to show that Al and Ga can be exchanged within the general formula of the luminophore:

TABLE 3

| Total formula | Sr[Li₃GaO₄]:Eu²⁺ | | Sr[Li₃Al_{0.25}Ga_{0.75}O₄]:Eu²⁺ | |
|---|---|---|---|---|
| Formula mass/g | 242.16 | | 231.59 | |
| mol⁻¹ | | | | |
| Z | 4 | | 4 | |
| Structure type | Sr[LiAl₃N₄] | | Sr[LiAl₃N₄] | |
| Crystal system | triclinic | | triclinic | |
| Room group | P1̅ | | P1̅ | |
| Grid parameters | a | 581.4(2) pm | a | 581.0(1) pm |
| | b | 737.5(2) pm | b | 737.6(2) pm |
| | c | 979.3(2) pm | c | 978.9(2) pm |
| | α | 84.186(8)° | α | 84.106(5)° |
| | β | 76.759(8)° | β | 76.740(5)° |
| | γ | 79.656(7)° | γ | 79.531(6)° |

| | | |
|---|---|---|
| Volume V | 0.4013(2) nm³ | 0.4007(2) nm³ |
| Crystallographic | 4.008 | 3.839 |
| density ρ/g cm⁻³ | | |
| T/K | 296 | 296 |
| Diffractometer | BRUKER D8 Quest | BRUKER D8 Quest |
| Radiation | Cu K_{α} (154.178 nm) | Cu K_{α} (154.178 nm) |
| Measuring range | 4.65 ≤ θ ≤ 64.19 | 4.65 ≤ θ ≤ 42.35 |
| Measured/ | 1117/911 | 537/401 |
| independent reflexes | | |
| Measured reciprocal | −6 ≤ h ≤ 6; | −4 ≤ h ≤ 4; |
| space | −8 ≤ k ≤ 8; | −6 ≤ k ≤ 6; |
| | 0 ≤ l ≤ 11 | −8 ≤ l ≤ 8 |
| Rₐₗₗ/wR_{ref} | 8.17%/18.97% | 7.09%/11.46% |
| GoF | 1.182 | 1.044 |

The crystallographic positional parameters of the refined structure of exemplary embodiment A2 are summarized in Table 4:

TABLE 4

| | Atomic | Wyckoff | | | | | |
|---|---|---|---|---|---|---|---|
| Name | type | location | x | y | z | Occupation | Uᵢₛₒ |
| Sr01 | Sr | 2i | 0.0097(7) | 0.6221(4) | 0.1177(4) | 1 | 0.0123(15) |
| Sr02 | Sr | 2i | 0.9741(9) | 0.8671(5) | 0.3768(4) | 1 | 0.0120(14) |
| Ga03 | Al | 2i | 0.4630(10) | 0.7938(8) | 0.1321(7) | 1 | 0.0090(17) |
| Ga04 | Al | 2i | 1.1671(9) | 0.6932(8) | 0.6542(8) | 1 | 0.0081(17) |
| O005 | O | 2i | 1.347(6) | 0.842(5) | 0.529(4) | 1 | 0.014(7) |
| O006 | O | 2i | 0.653(6) | 0.889(5) | 0.226(4) | 1 | 0.016(7) |
| O007 | O | 2i | 0.651(5) | 0.657(4) | −0.009(4) | 1 | 0.010(7) |
| O008 | O | 2i | 1.166(5) | 0.458(4) | 0.602(4) | 1 | 0.012(7) |
| O009 | O | 2i | 0.332(6) | 0.613(5) | 0.262(4) | 1 | 0.014(7) |
| O00A | O | 2i | 0.860(5) | 0.814(4) | 0.643(4) | 1 | 0.010(6) |
| O00B | O | 2i | 1.155(5) | 0.692(4) | 0.842(4) | 1 | 0.009(6) |
| O00C | O | 2i | 0.177(5) | 0.930(4) | 0.097(4) | 1 | 0.011(6) |
| Li06 | Li | 2i | 0.543(16) | 0.948(13) | −0.387(12) | 1 | 0.02(2) |
| Li05 | Li | 2i | 1.476(13) | 0.313(11) | 0.626(10) | 1 | 0.010(18) |
| Li04 | Li | 2i | 0.813(14) | 0.820(12) | −0.148(12) | 1 | 0.014(19) |
| Li03 | Li | 2i | 0.190(16) | 0.444(13) | 0.404(13) | 1 | 0.02(2) |
| Li02 | Li | 2i | 0.474(13) | 0.568(10) | −0.123(9) | 1 | 0.005(16) |
| Li01 | Li | 2i | 1.171(14) | 0.942(13) | 0.093(12) | 1 | 0.014(19) |

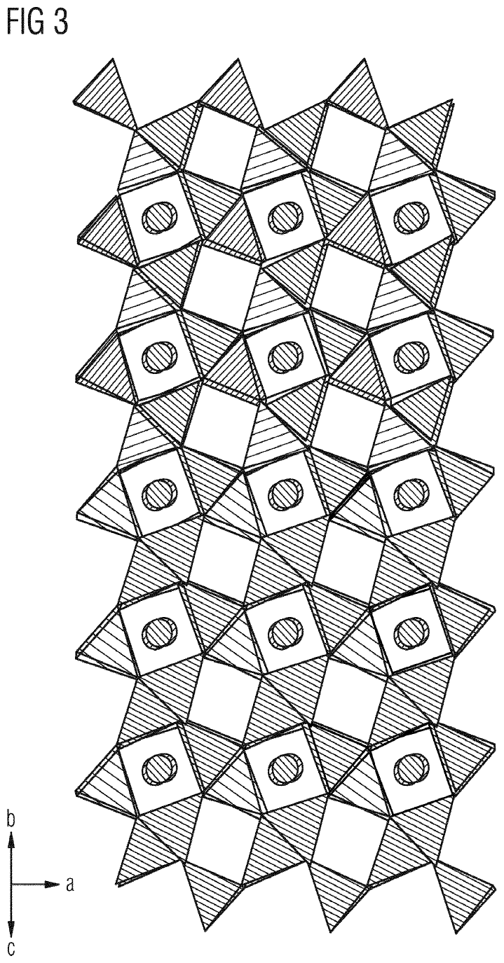

FIG. 3 schematically shows the crystal structure of the luminophore 1, which has a triclinic crystal structure. The structure is isotypical of that of the already known Sr[LiAl₃ N₄]:Eu (described in Pust, P. et al., Nat. Mater., 13, 891-896 (2014)). In FIG. 3, hatched circles represent Sr or Ba, closely hatched tetrahedra represent LiO₄ tetrahedra and widely hatched tetrahedra represent (Al,Ga)O₄ tetrahedra. The tetrahedra each have common edges and/or corners. LiO₄ tetrahedra can also be linked to each other via common edges, while GaO₄ tetrahedra are not. The tetrahedra are each spanned by four oxygen atoms or by three oxygen atoms and one nitrogen atom or by two oxygen atoms and two nitrogen atoms or by one oxygen atom and three nitrogen atoms, or by four nitrogen atoms. Li or Ga or Al are arranged in the resulting tetrahedral gaps. Sr or Ba, which are eightfold coordinated, is arranged in channels formed by the tetrahedra. Free channels are also present.

Table 5 shows the most important crystallographic data of the exemplary embodiments A1 to A6, which crystallize in the triclinic crystal structure, obtained from X-ray powder diffraction data:

TABLE 5

| | Volume | | | | | | |
|---|---|---|---|---|---|---|---|
| | [nm]³ | a [pm] | b [pm] | c [pm] | α [°] | β [°] | γ [ °] |
| A1 | 0.4025 | 582.0 | 738.5 | 980.0 | 84.195 | 76.770 | 79.610 |
| A2 | 0.4028 | 582.1 | 738.7 | 980.4 | 84.176 | 76.758 | 79.603 |
| A3 | 0.3925 | 575.9 | 733.4 | 973.5 | 83.896 | 76.609 | 79.560 |
| A4 | 0.3929 | 575.7 | 734.0 | 973.1 | 83.945 | 76.824 | 79.704 |
| A5 | 0.4116 | 586.0 | 744.9 | 986.2 | 84.191 | 76.785 | 79.645 |
| A6 | 0.4096 | 584.0 | 743.5 | 987.3 | 83.905 | 76.616 | 79.602 |

Table 5 shows that different compositions were formed according to exemplary embodiments Al to A6, as a result of which the lattice parameters changed.

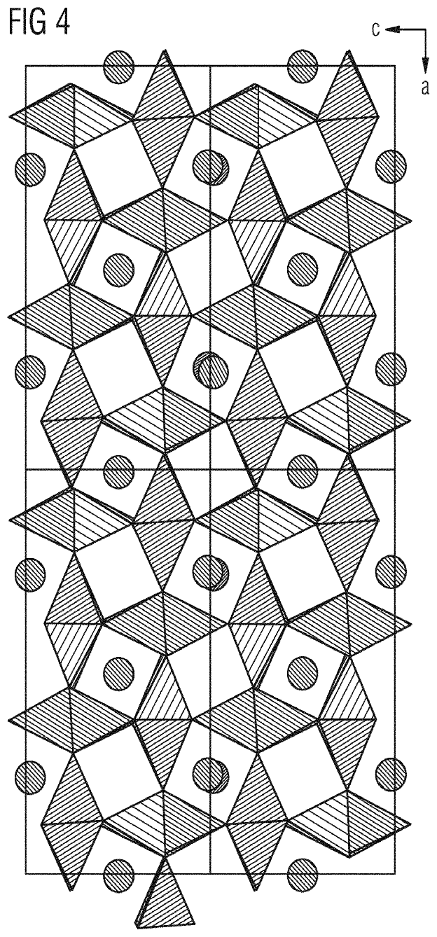

FIG. 4 shows the crystal structure of the monoclinic (Sr,Ba) (Li,Ga)₃Ga(O,N)₄:Eu along the crystallographic b-axis. Ba and Sr layers are shown as hatched circles, the Ga(O,N)4 tetrahedra are widely hatched and the (Ga,Li) (O,N)4 tetrahedra are narrowly hatched. This exemplary embodiment crystallizes in the space group C2/m with the lattice parameters a=1596(1), b=647(1), c=797(1) pm and β=90.00(1°) and a cell volume of 0.8238(5) nm³. The tetrahedra each have common edges and/or corners, whereby two (Ga,Li) (O,N)₄ tetrahedra can also have a common edge with each other. The tetrahedra are each spanned by four oxygen atoms or by three oxygen atoms and one nitrogen atom or by two oxygen atoms and two nitrogen atoms or by one oxygen atom and three nitrogen atoms or by four nitrogen atoms. Li and/or Ga are arranged in the resulting tetrahedral gaps. Ba and/or Sr, which are each eightfold coordinated, are located in the respective channels formed by the tetrahedra. There are also empty channels which are free of Ba and/or Sr.

FIG. 10 shows a schematic representation of the crystal structure of a luminophore 1 that crystallizes in the tetragonal crystal structure. The circles represent Sr or Ba layers, the hatched areas represent (Li,Ga,Al)(O,N)₄ tetrahedra, which are corner- and edge-linked. The tetrahedra are each spanned by four oxygen atoms or by three oxygen atoms and one nitrogen atom or by two oxygen atoms and two nitrogen atoms or by one oxygen atom and three nitrogen atoms or by four nitrogen atoms. The tetrahedra form channels in which Sr or Ba atoms are arranged or which are free of Sr or Ba atoms. In this embodiment, the luminophore 1 crystallizes in space group I4/m.

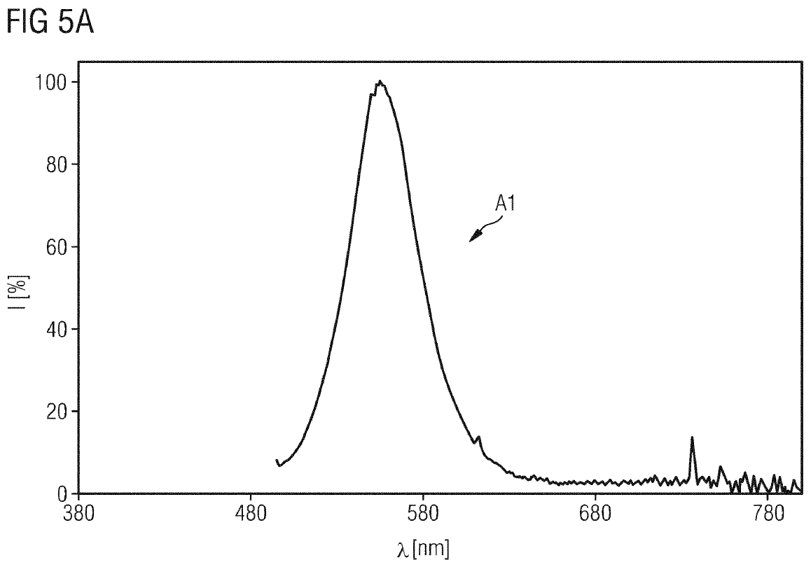

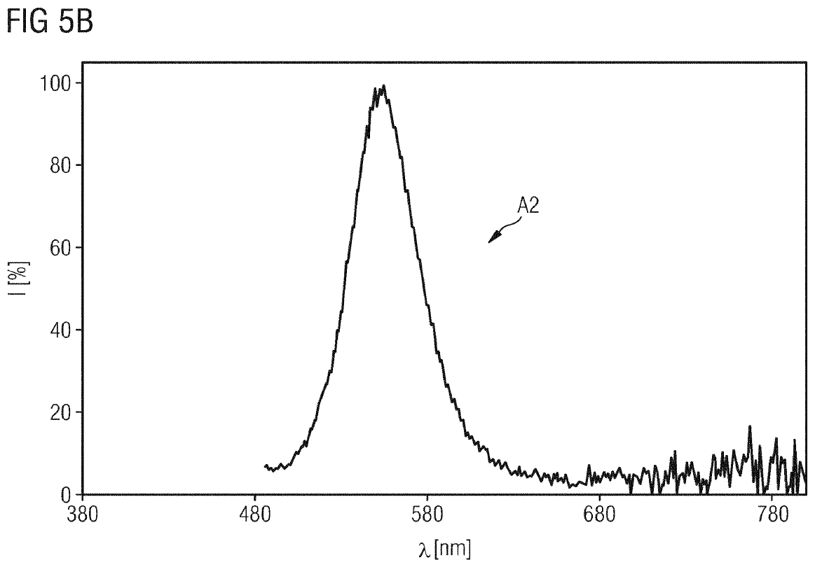

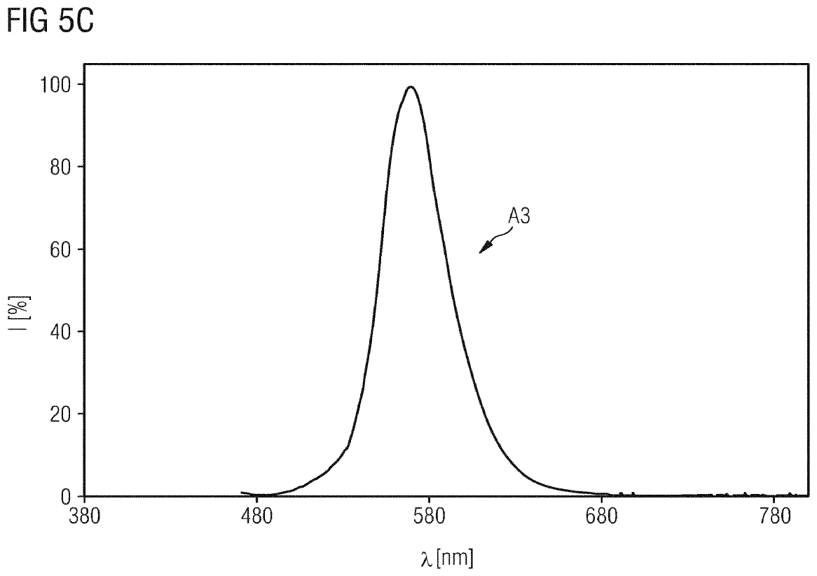

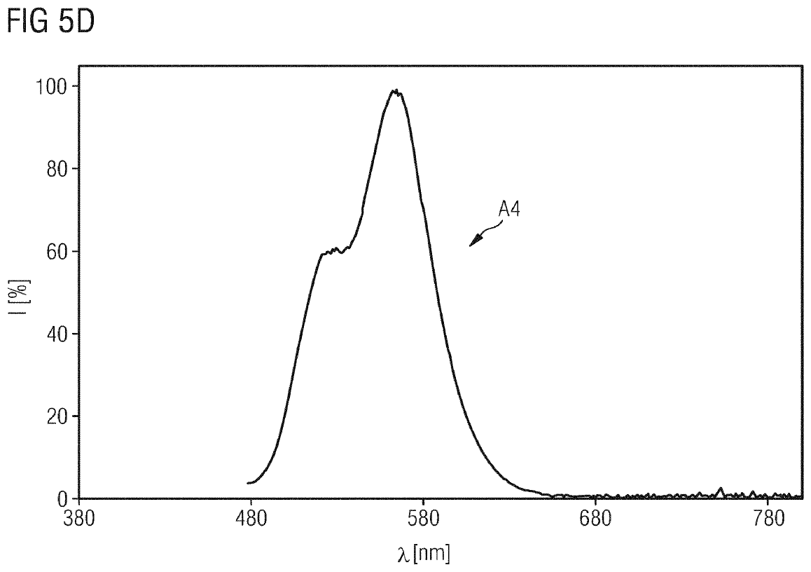

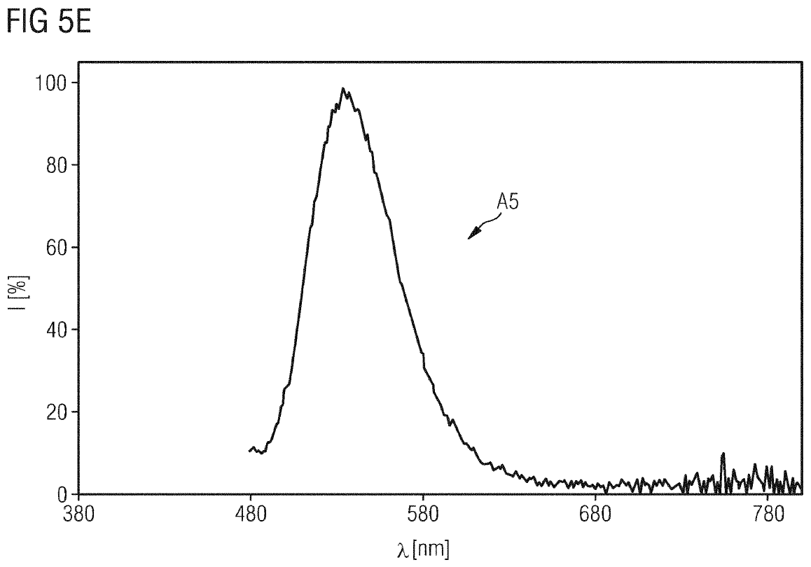

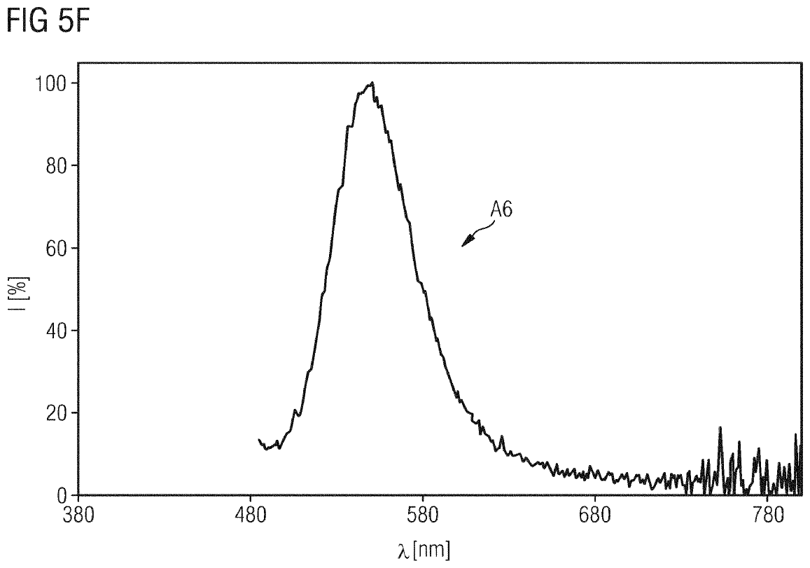

Emission spectra are also recorded from exemplary embodiments A1 to A6. The respective spectra are shown in FIGS. 5A to 5F. The excitation was carried out at 460 nm in each case.

In the spectra shown in FIGS. 5 to 8, the wavelength λ is shown in nm against the intensity I in %.

The luminophore 1 or the luminophore mixture 1′ according to exemplary embodiment Al emits yellow light with a dominant wavelength λ_{dom}=561 nm when excited with blue radiation. The spectral full width at half maximum of the emission is extremely narrow with 49 nm (FIG. 5A).

The luminophore 1 or the luminophore mixture 1′ according to exemplary embodiment A2 emits yellow light with a dominant wavelength λ_{dom}=560 nm when excited with blue radiation. The spectral full width at half maximum of the emission is extremely narrow with 43 nm (FIG. 5B).

The luminophore 1 or the luminophore mixture 1′ according to exemplary embodiment A3 emits yellow light with a dominant wavelength λ_{dom}=573 nm when excited with blue radiation. The spectral full width at half maximum of the emission is extremely narrow with 44 nm (FIG. 5C).

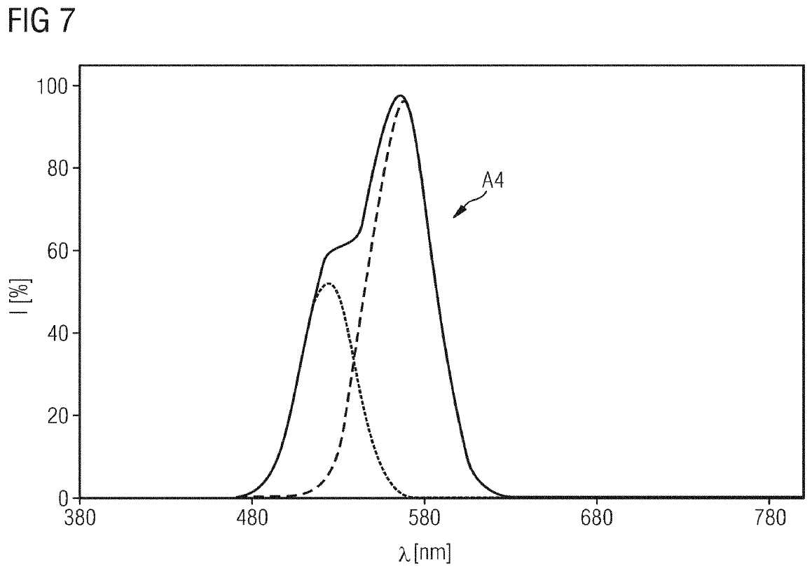

The luminophore 1 or the luminophore mixture 1′ according to exemplary embodiment A4 emits yellow-green light when excited with blue radiation (FIG. 5D). This consists of two individual emissions, the relative intensity of which can be adjusted via the precise synthesis conditions. The position of the two individual emissions of exemplary embodiment 4 is shown in detail in FIG. 7. There, the solid line represents the total emission, the dotted line the individual short-wave emission and the dashed line the individual long-wave emission. The maximum emission of the short-wave single emission is at approx. 524 nm, the maximum emission of the long-wave single emission is at approx. 567 nm. The individual full width at half maximum of the short-wave single emission is approx. 44 nm, that of the long-wave approx. 46 nm. The full width at half maximum of the entire emission band, which is created by superimposing the individual emissions, is 73 nm.

The luminophore 1 or the luminophore mixture 1′ according to exemplary embodiment A5 emits yellow-green light with a dominant wavelength λ_{dom}=549 nm when excited with blue radiation. The maximum of the emission is at Δₘₐₓ=538 nm (FIG. 5E). At 59 nm, the spectral full width at half maximum of the emission is with 59 nm narrower than that of known yellow-green emitting garnet luminophores, for example of the general composition (Y,Lu)₃(Al,Ga)₅O₁₂:Ce³⁺.

The luminophore 1 or the luminophore mixture 1′ according to exemplary embodiment A6 emits yellow-green light with a dominant wavelength λ_{dom}=558 nm when excited with blue radiation (FIG. 5F). At 58 nm, the spectral full width at half maximum of the emission is with 58 nm narrower than that of known yellow-green emitting garnet luminophores of the general composition (Y,Lu)₃(Al,Ga)₅O₁₂:Ce³⁺.

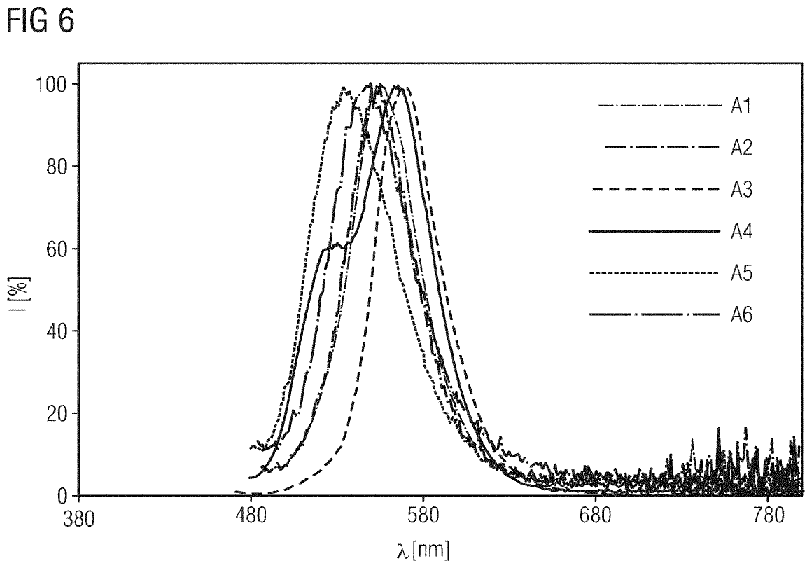

FIG. 6 shows all the emission spectra of the exemplary embodiments superimposed on one another. It can be seen that by varying the composition of the luminophore of the general formula Sr_{1-b}Ba_{b}Li₃Al₁₋ₓGaₓO_{4-y}N_{y}:Eu the exact emission position can be changed and thus adapted to the respective application.

The luminophore 1 or the luminophore mixture 1′ according to at least one exemplary embodiment of the present disclosure, can have clear advantages over already known luminophores due to their low spectral full width at half maximum. A commercially available garnet luminophore of the type (Y, Lu)₃^{(Al, Ga)}₅O₁₂: Ce³⁺ (hereinafter referred to as B1) is used below as an comparative example. This has a comparable color impression, measured by the dominant wavelength λ_{dom}, as the luminophore 1.

Table 6 compares comparative example B1 with exemplary embodiments A1 and A4. The dominant wavelength, the full width at half maximum FWHM and the relative luminous efficacy are listed.

TABLE 6

| luminophore | λ_{dom} | | FWHM | | $\frac{{η}_{v} ( exemplary embodiment )}{{η}_{v} ( comparative example )}$ |
|---|---|---|---|---|---|
| B1: Y₃Al_{3,5}Ga_{1,5}O₁₂:Ce | 561 | nm | 106 | nm | 100% |
| A1 | 561 | nm | 49 | nm | 124% |
| A4 | 561 | nm | 73 | nm | 117% |

Both exemplary embodiments have a significantly lower spectral full width at half maximum than the comparative example. In both cases, this narrower full width at half maximum leads to a significantly higher luminous efficacy, as can be seen from the relative luminous efficacy

$$\\ \frac{{η}_{v} ( exemplary embodiment )}{{η}_{v} ( comparative examplel )}$$

shown in Table 6. This approx. 24% increase in luminous efficacy can be directly advantageous for most conversion applications. When used as the sole luminophore in the conversion element of a component, this increased luminous efficacy corresponds to the efficiency gain of the conversion solution when using the luminophore 1 or the luminophore mixture 1′.

Even as part of a conversion solution with other luminophores in addition to the luminophore 1 or the luminophore mixture 1′, for example in white light-emitting diodes, the efficiency gain from the luminophore 1 or the luminophore mixture 1′ can lead to significant improvements. However, the exact size of the efficiency gain in a mixture also depends on the other luminophores in the mixture.

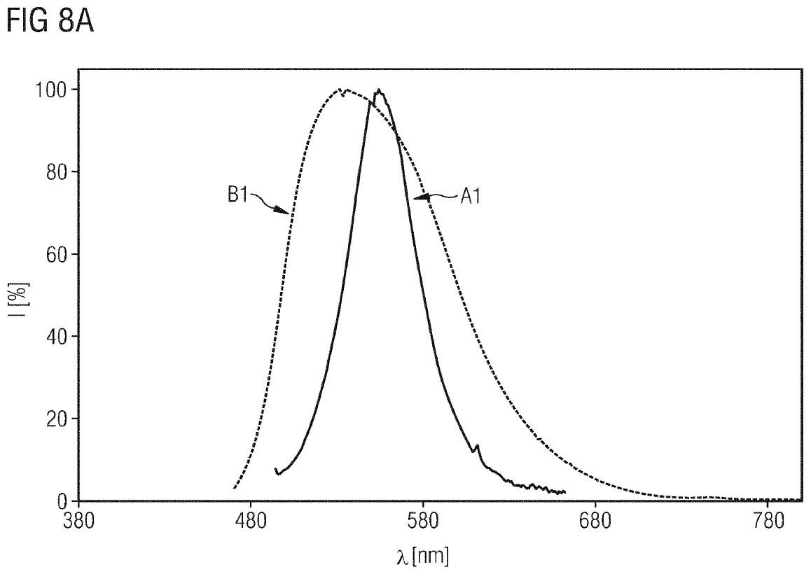

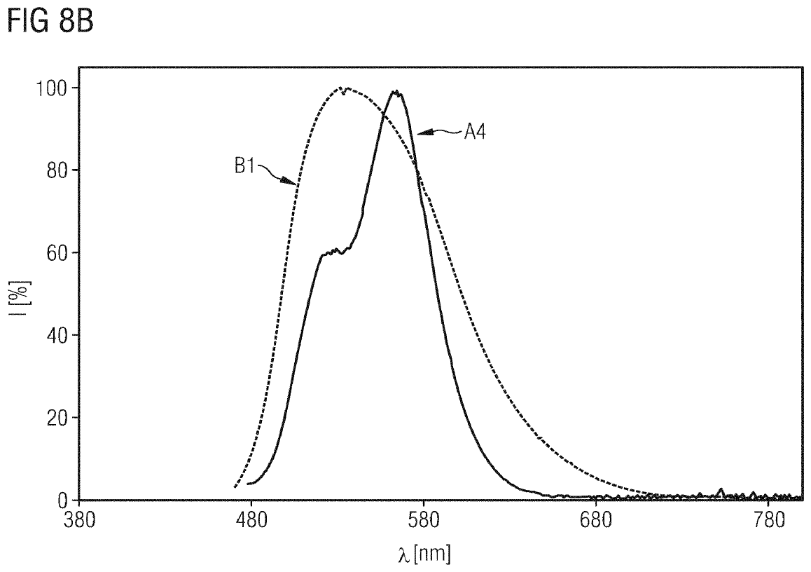

In the figures, the comparison of the exemplary embodiments A1 (FIG. 8A) and A4 (FIG. 8B) with the comparative example B1 is shown again in the form of their emission spectra. The solid lines represent the emission spectra of the exemplary embodiments, the dotted lines the emission spectra of the comparative example. The significantly reduced full width at half maximum of the emission spectra of the exemplary embodiments compared to the comparative example is clearly recognizable.

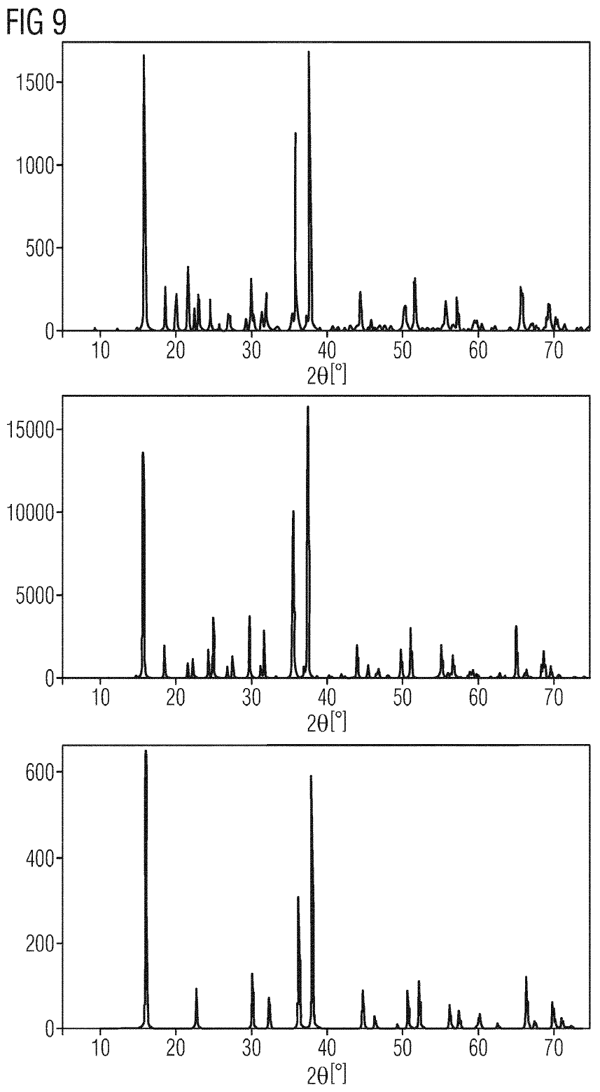

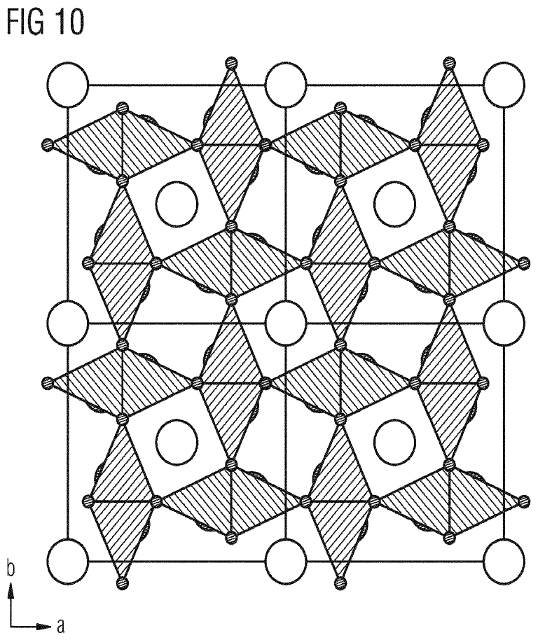

FIG. 9 shows powder X-ray diffractograms calculated from the single crystal data for a monoclinic (middle diffractogram), triclinic (upper diffractogram) and a tetragonal (lower diffractogram) phase. The diffraction angle 2Θ is plotted in ° against the intensity. This shows that a luminophore mixture 1′ has different phases in which the luminophore crystallizes differently and that the phases of a luminophore mixture 1′ can be distinguished from each other.

The features and exemplary embodiments described in connection with the figures can be combined with one another according to further exemplary embodiments, even if not all combinations are explicitly described. Furthermore, the exemplary embodiments described in connection with the figures may alternatively or additionally have further features as described in the general part.

The present disclosure is not limited to the description based on the exemplary embodiments. Rather, the present disclosure includes any new feature as well as any combination of features, which includes in particular any combination of features in the patent claims, even if this feature or combination itself is not explicitly stated in the patent claims or exemplary embodiments.

### LIST OF REFERENCE SIGNS

1 Luminophore
1′ Luminophore mixture
10 Semiconductor chip
11 Radiation exit area
12 Active zone
20 Conversion element
30 Housing
40 Potting
100 Radiation-emitting component
λ Wavelength
I Intensity
A1 Exemplary embodiment 1
A2 Exemplary embodiment 2
A3 Exemplary embodiment 3
A4 Exemplary embodiment 4
A5 Exemplary embodiment 5
A6 Exemplary embodiment 6
B1 Comparative example
2Θ Diffraction angle

What is claimed is:

1. A luminophore with the general formula Sr_{1-b}Ba_{b}Li₃Al₁₋ₓGaₓO_{4-y}N_{y}:Eu, where 0≤b≤1, 0<x≤1 and 0≤y≤1.

2. The luminophore according to claim 1, which crystallizes in a triclinic crystal structure.

3. The luminophore according to claim 1, which crystallizes in a monoclinic crystal structure.

4. The luminophore according to claim 1, which crystallizes in a tetragonal crystal structure.

5. The luminophore according to claim 1, which has an absorption spectrum which has an absorption maximum in a range from 400 nm to 500 nm.

6. The luminophore according to claim 1, which has an emission spectrum comprising at least one emission peak at a wavelength in a range from 510 nm to 580 nm.

7. The luminophore according to claim 6, wherein the emission spectrum has a dominant wavelength selected from a range of 540 nm to 580 nm.

8. The luminophore according to claim 6, wherein the at least one emission peak has a full width at half maximum that is less than 75 nm.

9. The luminophore according to claim 1, wherein Eu has a concentration of up to and including 10 mol % with respect to the total content of Sr and Ba.

10. The luminophore according to claim 1, comprising one of the compositions
Sr₁Li₃Ga₁O₄:Eu
Sr₁Li₃Ga₁O_{3,75}N_{0,25}:Eu
Sr₁Li₃Al_{0,8}Ga_{0,2}O_{3,75}N_{0,25}:Eu
Sr₁Li₃Al_{0,8}Ga_{0,2}O₄:Eu
Sr_{0,6}Ba_{0,4}Li₃Ga₁O₄:Eu
Sr_{0,5}Ba_{0,5}Li₃Al_{0,5}Ga_{0,5}O_{3,75}N_{0,25}:Eu.

11. A luminophore mixture containing at least two luminophores selected from the group consisting of
a luminophore having the general formula Sr_{1-b}Ba_{b}Li₃Al₁₋ₓGaₓO_{4-y}N_{y}:Eu, where 0≤b≤1, 0<x≤1 and 0≤y≤1, which crystallizes in a triclinic crystal structure,
a luminophore having the general formula Sr_{1-b}Ba_{b}Li₃Al₁₋ₓGaₓO_{4-y}N_{y}:Eu, where 0≤b≤1, 0<x≤1 and 0≤y≤1, which crystallizes in a monoclinic crystal structure,
and a luminophore having the general formula Sr_{1-b}Ba_{b}Li₃Al₁₋ₓGaₓO_{4-y}N_{y}:Eu, where 0≤b≤1, 0<x≤1 and 0≤y≤1, which crystallizes in a tetragonal crystal structure.

12. A method for producing a luminophore having the general formula Sr_{1-b}Ba_{b}Li₃Al₁₋ₓGaₓO_{4-y}N_{y}:Eu, where 0≤b≤1, 0<x≤1 and 0≤y≤1,
comprising:
providing a mixture of reactants selected from a group comprising oxides, nitrides, carbonates, nitrates, oxalates, citrates and hydroxides of Sr, Ba, Li, Al and Ga, respectively, and combinations thereof,
homogeneously mixing the reactants,
heating the reactants to a temperature selected from a range of 600° C. to 1000° C.

13. The method according to claim 12, wherein the temperature is selected from a range of 750° C. to 850° C.

14. The method according to claim 12, wherein the reactants are selected from at least one of the group of SrO, BaO, BaGa₂O₄, Ga₂O₃, Li₂O, SrAl₂O₄, SrGa₂O₄, GaN, Sr₃Al₂N₄ and Eu₂O₃.

15. The method according to claim 12, wherein the heating is carried out in a forming gas atmosphere.

16. The method according to claim 12, wherein the heating is carried out for a period of from 2.5 hours to 6 hours.

17. The method according to claim 12, wherein the heating is carried out at normal pressure.

18. A radiation-emitting component comprising:
a semiconductor chip which, in operation, emits electromagnetic radiation of a first wavelength range from a radiation exit surface, and
a conversion element on the radiation exit surface, which comprises a luminophore according to claim 1, which converts electromagnetic radiation of the first wavelength range into electromagnetic radiation of a second wavelength range, or a luminophore mixture according to claim 11, which converts electromagnetic radiation of the first wavelength range into electromagnetic radiation of a second wavelength range.

19. The radiation-emitting component according to the claim 18, which is free of a further luminophore.

20. The radiation-emitting component according to claim 18, wherein at least one further luminophore is present in the conversion element.
